(19) United States
(12) Patent Application Publication
(10) Pub. No.: US 2011/0167100 A1
(43) Pub. Date: Jul. 7, 2011

(54) COOKING SUPPORT DEVICE

(75) Inventor: Adam Brodowski, Brooklyn, NY (US)

(73) Assignee: Aktiebolaget Electrolux, Stockholm (SE)

(21) Appl. No.: 12/987,074

(22) Filed: Jan. 7, 2011

Related U.S. Application Data
(63) Continuation-in-part of application No. PCT/SE2009/000320, filed on Jun. 23, 2009.

(30) Foreign Application Priority Data
Jul. 8, 2008 (SE) 0801641-2

(51) Int. Cl. G06F 1/16; G06F 17/00; G06F 3/00

(52) U.S. Cl. 708/105; 708/133

(57) ABSTRACT

A cooking support device. The cooking support device serves the function of a recipe generator and can be used to share recipes on the internet. The cooking support device may include a base, a display, and an electronic cutting board. The cooking support device includes a plurality of sensors to identify the food in inventory and the food being prepared. An RFID reader can identify RFID tags on foods. The cutting board may include a weight sensor, an electronic tongue, and/or a moisture sensor to help identify the food being prepared on the cutting board. The display includes a touch sensitive display region to enable the user to interactively add items, create and revise recipes, and perform other functions. The cooking support device enables the user to integrate the process of cooking in the kitchen with social networking by creating and sharing recipes.

### CROSS REFERENCE TO RELATED APPLICATION

This application is a continuation-in-part of International Application No. PCT/SE2009/000320 filed Jun. 23, 2009 entitled COOKING SUPPORT DEVICE, which claims priority from Swedish Application No. 0801.641-2 filed Jul. 8, 2008 entitled COOKING SUPPORT DEVICE, the entire contents of both are incorporated herein by reference.

### FIELD and BACKGROUND

The disclosure relates to a cooking support device which facilitates cooking, recipe making and sharing.

Almost all of the population of generation Y is owns a computer. As a whole, they are very comfortable with technology and the Internet. The majority of those people belong to social networking sites such as Facebook. Additionally, many of them run personal blogs, search the web for extended hours, and frequently use email as a communication tool. Many of them also enjoy creating content to fuel the web.

The people of generation Y are also generally “hyper-taskers”—doing multiple things at once. For example, it is not uncommon for many of them to be eating dinner, text messaging, doing homework, and watching TV simultaneously.

### BRIEF SUMMARY

Aspects of the disclosure pertain to a cooking support device which includes a system that stores the food the user has available and can provide suggestions to mix and match the foods and flavours to make unique dishes. Another aspect is that the system can identify foods and generate recipes based on the user's cooking process without the user needing the write and type the entire recipe. Another aspect is that the system enables the user to create unique content for the World Wide Web, share the recipes with his or her friends easily, and become noticed on the web for the generated content. Another aspect is that the system enables the user to discover a drive to experiment with cooking meals without the process of recipe keeping and the efforts associated with traditional on-the-spot recipe creation that commonly requires simultaneous cooking and writing.

According to another aspect, a cooking support device includes a recipe generator.

According to another aspect, a cooking support device includes a base, a touch screen display configured to be coupled to the base, and an electronic cutting board. The base includes a wireless transmitter-receiver. The electronic cutting board is physically distinct from the base and the touch screen display and is configured to be coupled to the base. The electronic cutting board includes at least one sensor.

According to another aspect, a cooking support device includes a display, an electronic cutting board physically distinct from the display, and a base. The display includes an interactive touch screen display region and a stand enabling it to remain in an upright configuration. The electronic cutting board includes a horizontal cutting surface portion, an upstanding lip, and at least two sensors of different types configured to identify food on the horizontal cutting surface portion. The base including a wireless transmitter-receiver, a first dock for receiving the display, and a second dock for receiving the electronic cutting board.

### BRIEF DESCRIPTION OF THE DRAWINGS

The foregoing summary as well as the following detailed description, considered in conjunction with the accompanying drawings, provide a better understanding, in which like reference numbers refer to like elements, and wherein:

FIG. 1 is a side view of a cooking support device according to an embodiment of the disclosure;

FIG. 2 is a perspective view of the cooking support device;

FIG. 3 is a rear view of the cooking support device with the electronic cutting board removed from the base;

FIG. 4 is a perspective view of the electronic cutting board and the display both removed from the base and in a use configuration;

FIG. 5 is a perspective view of the base;

FIG. 6 is a perspective view of the electronic cutting board;

FIG. 7 is a perspective view of the display unit;

FIG. 8 is a perspective view of the display unit adjacent a cooked meal;

FIG. 9 is a front view of an interface for the display in a first illustrative state;

FIG. 10 is a front view of the interface for the display in a second illustrative state;

FIG. 11 is a front view of the interface for the display in a third illustrative state.

### DETAILED DESCRIPTION

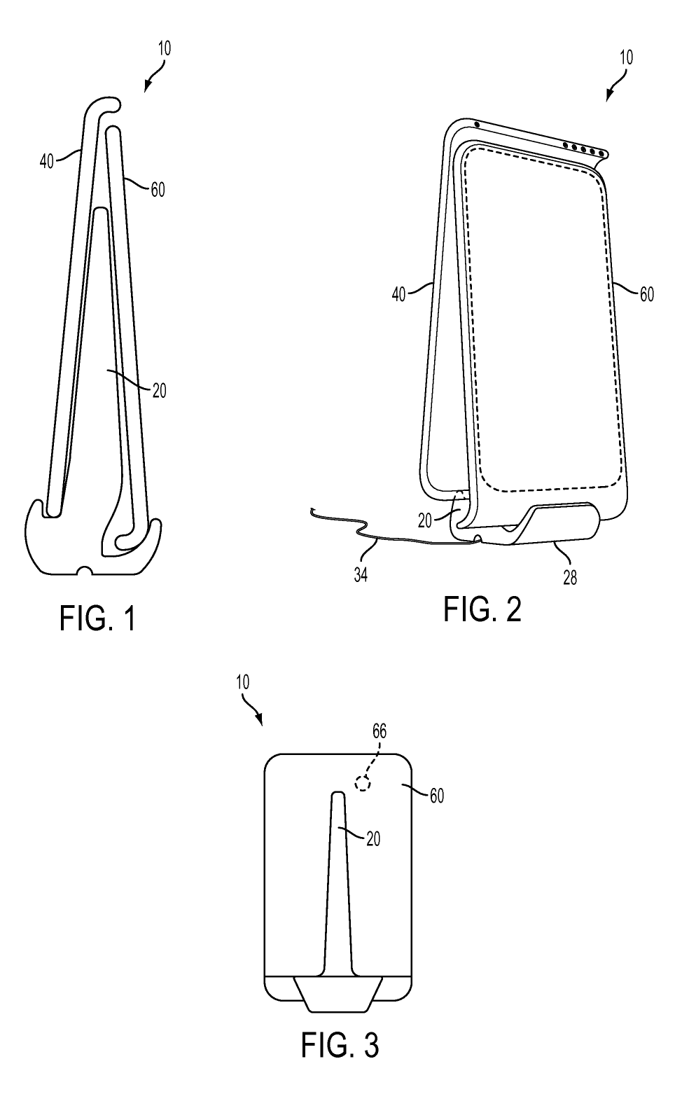

FIGS. 1-11 illustrate details of a cooking support device 10. In an illustrative embodiment, the cooking support device 10 includes three units: a base 20, an electronic cutting board 40, and a display 60. The features of the cooking support device 10 enable the user to integrate the process of cooking in the kitchen with social networking. The cooking support device 10 also facilitates the users being able to create and share recipes that they make when they are experimenting with cooking.

As can be seen from FIG. 1, the base 20 has a configuration that includes a bottom portion 26 and an upstanding tower 22. The bottom 26 of the base 20 can dock the electronic cutting board 40 and the display 60. More specifically, as shown in the FIGS. 1, 2, and 5, the base 20 includes a first recess 30 that receives the display 60, and a second recess 32 that receives the electronic cutting board 40. The first recess 30 and the second recess 32 may be positioned on opposite sides of the upstanding tower 22. This configuration, with the shapes of the upstanding tower 22, the electronic cutting board 40 and the display 60 provides a compact arrangement and further allows a lip portion 44 of the electronic cutting board 40 cover the display 60. The bottom 26 also includes a surface 28 enabling the base 26 to stand in a stable upright position.

The base 20 may also include a power supplying cord 34 to supply power to the base 20. In one arrangement, the base 20 can act as a charger for charging the electronic cutting board 40 and the display 60 in the docked position. In an alternative configuration, the base 20 can be battery powered and charged in any desirable manner.

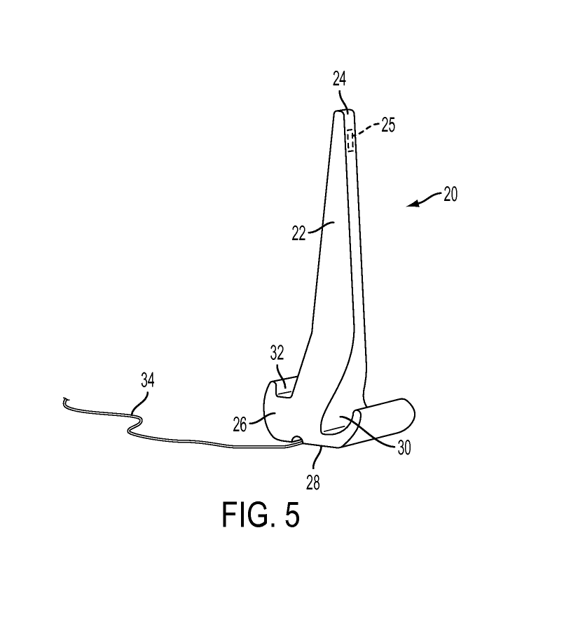

The base 20 also includes as a radio-frequency identification scanner/reader 25. The radio-frequency identification scanner 25 is schematically shown in FIG. 5 and may be positioned on the upstanding tower 22. The radio-frequency identification scanner 25 will detect any groceries coming into the kitchen having RFID tags thereon. Once detected, it can electronically process them and log them in to the system. Once the system knows what food is in the kitchen and can be used in recipes, it can begin to download recipes to suggest. By knowing the food on hand, it can also help identify ingredients that might be used in later-created recipes. That is, the radio-frequency identification scanner 25 is one method the cooking support device 10 can detect and identify ingredients. Data on RFID tags associated with foods/food packaged may also include other information such as more detailed ingredient information, and/or food preparation suggestions.

The base 20 also includes as a wireless communication system, schematically illustrated by reference number 24 in FIG. 5. The wireless communication system 24, which may include a wireless transmitter and receiver, can be used to interacting with other systems, for example other systems via the internet.

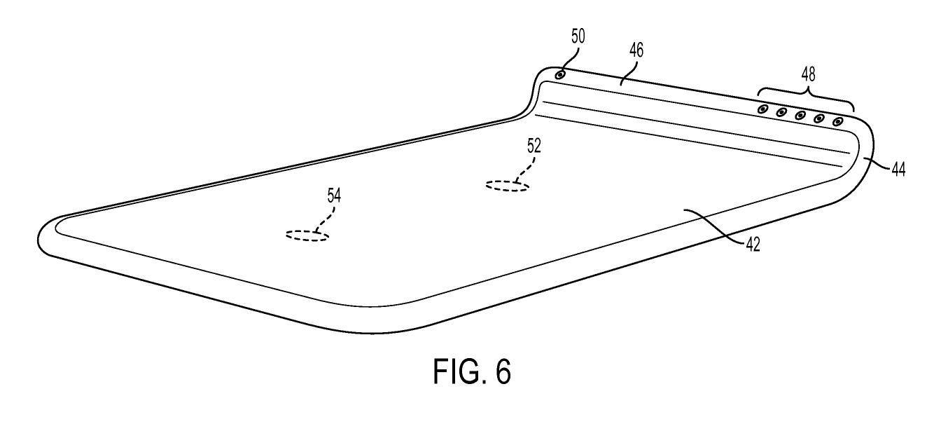

FIG. 6 shows the electronic cutting board 40 in isolation. As shown, the electronic cutting board 40 may be configured to include a horizontal cutting surface portion 42 and an upstanding lip 44. The electronic cutting board 40 includes a plurality of sensors that can detect and help identify what food is on the cutting board 40, and more specifically the food on the cutting surface portion 42. The food identifying sensors on the cutting board 40 can include one or more of: a weight sensor, an electronic tongue, a moisture sensor. In the depicted embodiment, all of a weight sensor (schematically illustrated by reference number 52), an electronic tongue (schematically illustrated by reference number 54), and a moisture sensor 50 are included.

The weight sensor 52 may be positioned on or in the horizontal cutting surface portion 42 of the cutting board 40. Any suitable sensor can be used to achieve this result. This sensor can determine the weight of food on the cutting board 40. Using this information, alone and/or with other sensors, a more precise determination about the food can be made. For example, it could assist in determining whether a pound of chicken is on the cutting board 40, or whether it is just a breast. Accordingly, knowing the weight of the food on the cutting board 40, in combination with the other sensors, foods that do not match can be removed.

The electronic tongue 54 can also be positioned on the horizontal cutting surface portion 42 of the cutting board 40. The electronic tongue 54 is a sensor allowing a digital interpretation of taste. In one arrangement, the electronic tongue 54 includes a small silicon chip that includes various flavor cells lining it. Basically, from the information provided by the electronic tongue, alone and/or with other sensors, a more precise determination about the food can be made. For example, the electronic tongue 54 can provide information to help determine whether a food was bitter or spicy.

The moisture sensor 50 may be provided on an upstanding lip 44 of the electronic cutting board 40. If desired, the moisture sensor 50 could be located on the lip edge 46 of the lip 44. The moisture sensor 50 may include an IR camera. Using radio waves and the IR camera, the moisture sensor 50 can help to detect the moisture of the food placed on the cutting board 40. This information, alone and/or with other sensors, can narrow the possibilities of foods and help to make a more precise determination about the food.

The electronic cutting board 40 includes a battery, not shown. The electronic cutting board 40 includes a set of LEDs 48 that can provide the user an indication about the amount of charge of the battery. If desired, the set of LEDs 48 can be located on the lip edge 46 to help facilitate observation by the user. The battery of the electronic cutting board 40 may be charged in any suitable manner including being charged by the base 20 if docked. Additionally, the electronic cutting board 40 is waterproof to enable it to be cleaned easily after cooking.

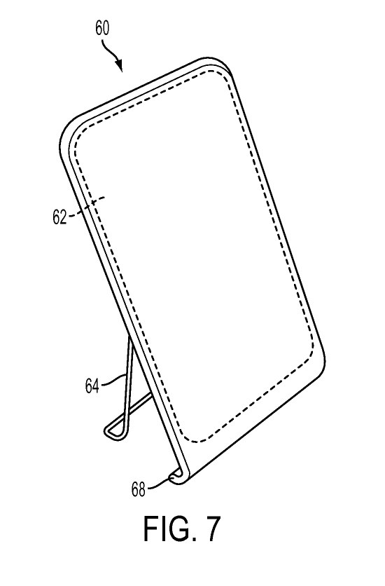

FIG. 7 shows the display 60 in isolation. Display 60 includes a display region 62 on its front face which is preferably touch sensitive so as to be an interactive touch screen. The display region 62 can be used for displaying recipes, ingredients, pictures, and other items to facilitate the effectiveness of the cooking support device 10 for the functionalities described.

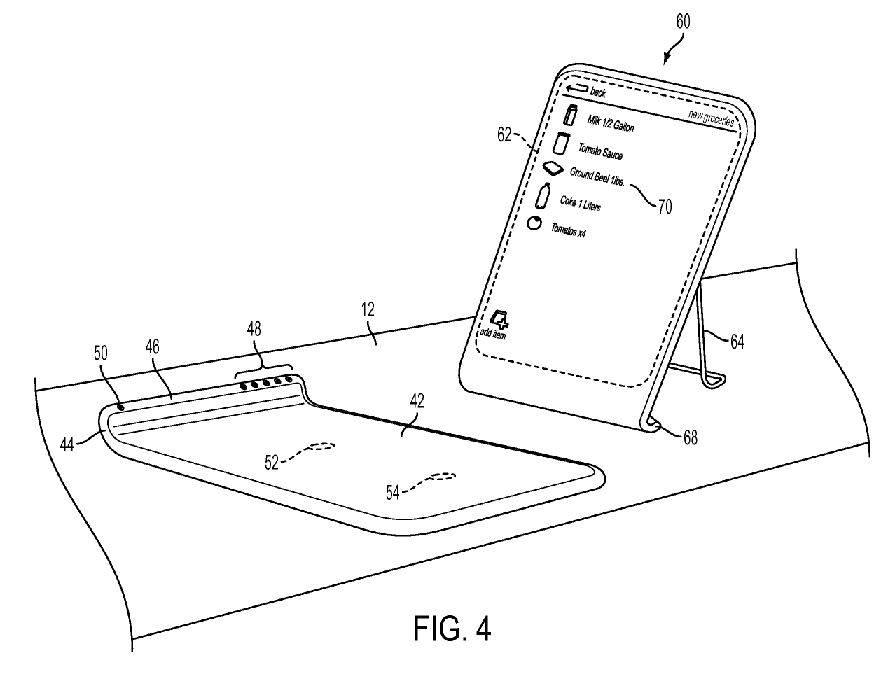

The display 60 further includes a stand 64. The stand 64 can be moved between an extended position (such as seen in FIGS. 4 and 7) to enable the display 20 to remain in a stable upright configuration, and a retracted position (such as seen in FIGS. 1-2) to better enable it to dock within the base 20. The display 60 also includes a bent bottom edge 68 not in the plane with the display region 62 to enable the display 20 to be more stable in an upright configuration. The bent bottom edge 68 also serves to aid in the gripping of the display 60 by the user.

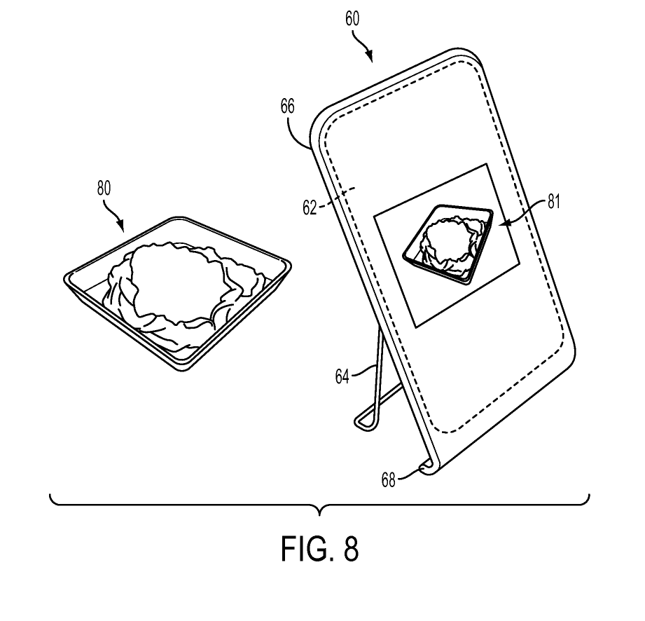

Additionally, the display 60 further includes a camera having its lens 66 on the rear face of the display 60. That is, the lens 66 of the camera is on the side of the display 60 that is opposite from the display region 62. However, it is recognized that the lens may be positioned elsewhere on the display 60 including on its front face. As shown in FIG. 8, the camera enables the display to take an image 81 or movie of a dish of food 80. The image 81 or movie can later be stored for retention and/or uploaded to the internet to share with others.

The display 60 also preferably includes a battery. The battery of the display 60 may be charged in any suitable manner including being charged by the base 20 if docked. Like the electronic cutting board 40, the display 60 is preferably waterproof to be cleaned easily after cooking.

FIG. 4 shows the electronic cutting board 40 and the display 60 undocked from the base 20 and in a use position on a suitable supporting surface 12, such as a table or countertop. The portability and flexibility of the electronic cutting board 40 and the display 60 facilitates the user being able to cook and create recipes with feedback from the cooking support device 10. Further, this arrangement can also display each item and step in a recipe being built added one at a time as the meal is prepared on the cutting board 40. When the meal is done the recipe can be uploaded online for others to see and use.

It is recognized that the base 20, the electronic cutting board 40, and the display 60 each have suitable computer/processing and memory capabilities to enable them to perform their functions. Additionally, the base 20, the electronic cutting board 40, and the display 60 each preferably include suitable capability to communicate with each other, preferably all wirelessly via any suitable technique, so that the information obtained, calculated, determined, and/or provided by each can be shared as part of the overall functioning of the cooking support device 10.

In use, when new groceries are detected by the base 20, such as by the RFID scanner 25, they are added to a list of available foods. The display 60 reflects each added items and the user can add additional foods manually via the touch sensitive display 62 and rectify any mistake made by a sensor. Accordingly, the cooking support device 10 knows not just the foods on hand; it also uses its series of sensors to detect what food is on near the electronic cutting board 40.

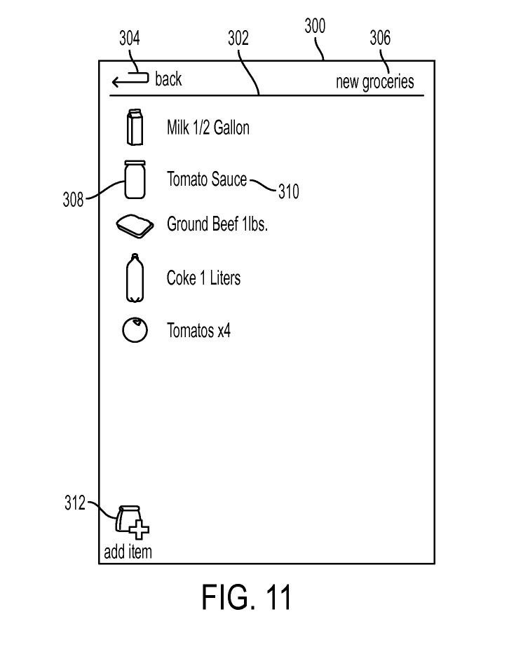

FIG. 11 shows an interface 300 that may be used on the touch screen display region 62 to help affect the functionality of the cooking support device 10. Specifically, this interface may be used to show food the user has available or on-hand based from the information obtained by the RFID reader 25 or manually added by the user. The interface 300 includes an upper toolbar area 302. Contained in the toolbar area 302 is an icon 304 to enable the user to go to a previous menu in the hierarchy, and indicia 306 to enable the user to add new groceries. The lower icon 312 enables the user to add new items to the food and/or recipe ingredient list. Each listed item preferably includes a typed description 310 of the food and a corresponding icon 308. The icons 308 corresponding to the food quickly and simply enables the user to make selections and modifications during the recipe creation and inventory additions, which may be import if the user is simultaneously preparing the food.

To start the use of the cooking support device 10 for cooking and/or building or modifying a recipe, the electronic cutting board 40 and the display 60 are taken off of the base 20 and a new recipe is started up if desired. Alternatively, if the user chooses to make a recipe they have downloaded or have stored, the cooking support device 10 uses its sensors to identify the food being used and helps to guide the cooking process. The cooking support device 10 can help to turn a normal recipe into a recipe that can be adapted based on food amounts, diet needs, and helps to keep the meal on track auto alerting when food is finished.

To create a recipe, ingredients may be selected, for example by dragging and dropping the icon of the food type. The user may also be presented with an option to describe the cooking type. Additional items can be manually added. Spices can be added manually to allow for a precise amount to be entered into the recipe.

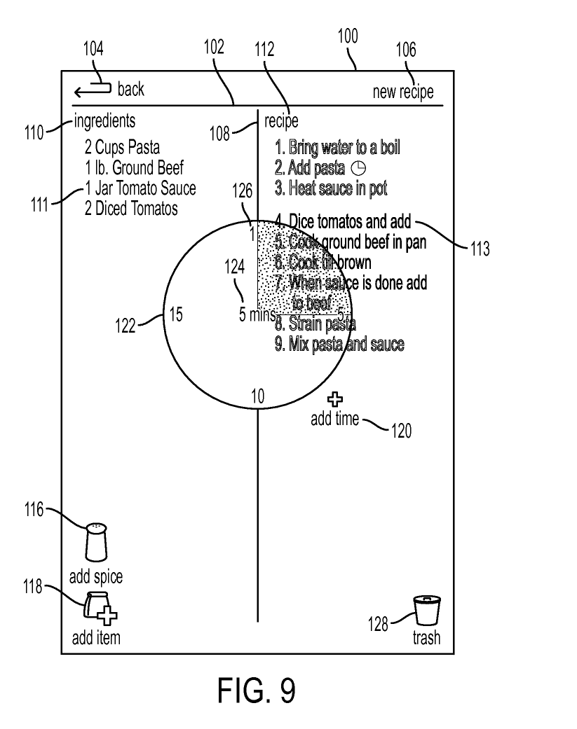

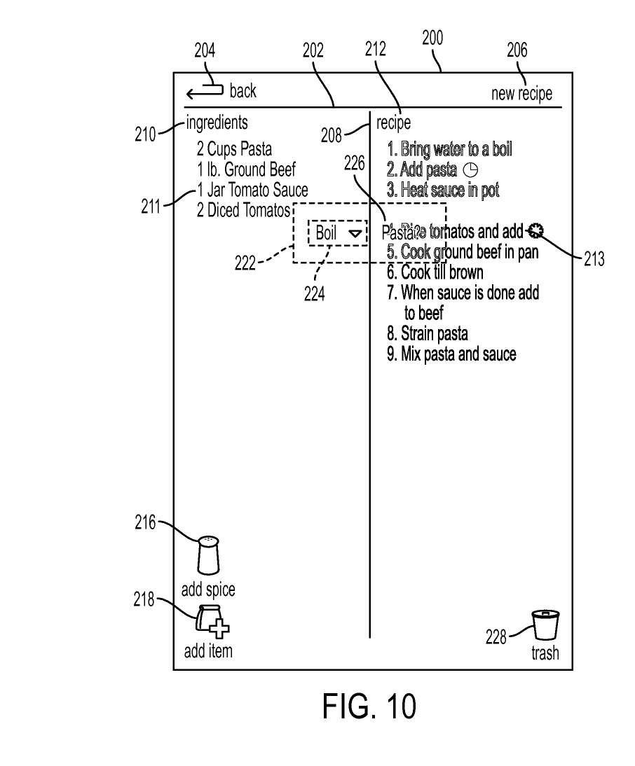

FIGS. 9 and 10 show an interface that may be used on the touch screen display region 62 to help affect the functionality of the cooking support device 10. FIG. 9 shows the interface 100 having an upper toolbar area 102. Contained in the toolbar area 102 in the state include an icon 104 to enable the user to go to a previous menu in the hierarchy, or indicia 106 to enable the user to select a new recipe to be created. The interface 100 may be vertically divided by a divider line 108. The divider line 108 helps organize the process such that the ingredients 111 of a recipe can be specifically listed and itemized in an ingredient column 110 on one side of the divider line 108. A recipe column 112 on the other side of the divider line 108 can contain preparation steps 113 for the recipe.

In addition to the ingredients automatically added to the ingredient list 110 by the sensors, the user via the interface can select icons 116 and/or 118 to add spices or other items, respectively, to the recipe. A trash icon 128 can be used as desired to delete an ingredient, a cooking step, or the recipe being created.

By selecting a small timer icon, the user can bring up a large clock interface 122. This selection can be done by any suitable process, such as by double tapping on the small timer icon. The user can use the interface 122 to select, by dialing for instance, the time they want to include in the recipe by selecting a value 126. The amount of time selected appears in the center 124 of the interface. The user can add more time or check remaining time by double tapping the icon again or double tapping on a time modifying icon 120. The clock also serves as timer. When the timer is up, the display region 62 will flash and an alarm sounds. This allows food to be cooking properly and a current cook time attached to the recipe.

FIG. 10 shows the interface 200, similar to interface 100, with an upper toolbar area 202, previous menu icon 204, new recipe indicia 206, divider line 208, ingredient column 210 with ingredients 211, recipe column 212 with preparation steps 213, add spice icon 216, add item icon 218, and trash icon 228. FIG. 10 further includes an interface region 222 to assist in creating preparation steps. In the illustrative recipe shown in the figure, a cooking type 224 can be selected or revised from a pull down menu as it would be applied to a particular food 226 or food mixture. Additionally, “Pro Facts” or tips can appear next to items on the display during this process. When such is presented, the user may select such indicia, for example by double clicking on a pop up screen, to help the cook.

When the meal is done, a description and extra notes can be added to the recipe. To finalize the recipe a photo may taken with the camera of the display. The completed recipe can be uploaded online or emailed to a friend who might like it. Accordingly, the cooking support device 10 assists in generating a recipe and also in sharing it with other people. As the recipe is digitally created, it is easy to post it online.

While the present invention has been described with reference to exemplary embodiments, it will be understood by those of ordinary skill in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiments disclosed, but that the invention will include all embodiments falling within the scope of the appended claims.

What is claimed is:

1. A cooking support device comprising a recipe generator.

2. The cooking support device according to claim 1, wherein the recipe generator comprises detector means for identifying ingredients.

3. The cooking support device according to claim 2, wherein the detector means includes an RFID scanner on a base station for identifying ingredients.

4. The cooking support device according to claim 3, wherein the base station further includes a wireless communication system for interacting with the internet.

5. The cooking support device according to claim 4, further comprising a cutting board and the detector means further includes at least one of a moisture sensor, weight sensor and electronic tongue arranged in the cutting board.

6. The cooking support device according to claim 5, further comprising a screen unit.

7. The cooking support device according to claim 6, wherein the screen unit includes a touch screen for displaying recipes and ingredients.

8. The cooking support device according to claim 1, further comprising a cutting board and at least one of a moisture sensor, weight sensor and electronic tongue arranged in the cutting board.

9. The cooking support device according to claim 1, further comprising a screen unit.

10. A cooking support device comprising:
a base, the base including a wireless transmitter-receiver;
a touch screen display configured to be coupled to the base; and
an electronic cutting board physically distinct from the base and the touch screen display and configured to be coupled to the base; the electronic cutting board including at least one sensor.

11. The cooking support device according to claim 10, wherein the base includes a first dock for receiving one of the touch screen display and the electronic cutting board.

12. The cooking support device according to claim 11, wherein the base includes a second dock for receiving the other one of the touch screen display and the electronic cutting board.

13. The cooking support device according to claim 12, wherein the base includes an RFID reader.

14. The cooking support device according to claim 10, wherein the touch screen display includes a front face having a touch screen display, a rear face having a camera lens, and a stand enabling the touch screen display to remain in an upright configuration.

15. The cooking support device according to claim 10, wherein the electronic cutting board further includes a horizontal cutting surface portion and an upstanding lip, said at least one sensor being a first sensor located at the horizontal cutting surface portion.

16. The cooking support device according to claim 15, wherein the first sensor is a weight sensor.

17. The cooking support device according to claim 15, wherein the first sensor is an electronic tongue.

18. The cooking support device according to claim 15, wherein the electronic cutting board further includes a second sensor located on the upstanding lip.

19. The cooking support device according to claim 18, wherein the upstanding lip includes a top edge, and wherein the electronic cutting board further includes LED indicators located on the upstanding lip.

20. A cooking support device comprising:
a display, the display including an interactive touch screen display region and a stand enabling the display to remain in an upright configuration;
an electronic cutting board physically distinct from the display; the electronic cutting board including a horizontal cutting surface portion, an upstanding lip, and at least two sensors of different types configured to identify food on the horizontal cutting surface portion; and
a base, the base including a wireless transmitter-receiver, a first dock for receiving the display, and a second dock for receiving the electronic cutting board.
